(19) United States
(12) Patent Application Publication
(10) Pub. No.: US 2012/0112703 A1
(43) Pub. Date: May 10, 2012

(54) System and Method for Managing a Battery

(75) Inventors: Shungang Xu, Shanghai (CN); Jianping Xu, Chengdu (CN); Shaolan Wang, Beijing (CN); Wei Zhang, Shanghai (CN); Tao Zhang, Shanghai (CN); Jingbo Ke, San Jose, CA (US)

(73) Assignee: O2 MICRO, INC., Santa Clara, CA (US)

(21) Appl. No.: 13/154,770

(22) Filed: Jun. 7, 2011

(30) Foreign Application Priority Data
Nov. 4, 2010 (CN) 201010538182.X

(51) Int. Cl. H02J 7/04

(52) U.S. Cl. 320/145; 320/162

(57) ABSTRACT

A method for managing a battery with multiple battery cells is disclosed. The method includes monitoring parameters of the battery cells by an information acquisition unit. Parameters of the battery cells include individual cell voltages. The method further includes selecting, by a controller one of multiple charging modes in which the battery cells are charged according to the cell voltages. The charging modes include a constant current charging mode, a constant voltage charging mode, and a pulse charging mode.

### CROSS REFERENCE TO RELATED APPLICATION

This application claims priority to Patent Application Number 201010538182.X, filed on Nov. 4, 2010 with the State Intellectual Property Office of the P.R. China (SIPO), which is hereby incorporated by reference.

### BACKGROUND

A battery including multiple battery cells can be used in various applications, such as laptop computers, electric vehicles (EVs), hybrid electric vehicles (HEVs), and energy storage systems. A conventional battery management system is used to manage the battery cells based on the voltage of the whole battery in the charging mode. However, due to different features, e.g., internal resistance and capacity of the battery cells, some of the battery cells in a battery are over-charged while other battery cells in the same battery are under-charged during a charging operation. Consequently, the degrading rate of the battery is increased and the lifetime of the battery is shortened.

### SUMMARY

An embodiment of a method for managing a battery including multiple battery cells is disclosed. The method includes monitoring parameters of the battery cells by an information acquisition unit. Parameters of the battery cells include cell voltages. The method further includes selecting, by a controller, one of multiple charging modes in which the battery cells are charged according to the cell voltages. The charging modes include a constant current charging mode, a constant voltage charging mode, and a pulse charging mode.

In another embodiment, a battery management system for a battery composed of a plurality of battery cells is disclosed. The battery management system comprises an information acquisition unit for monitoring parameters of the battery cells, wherein said parameters comprise cell voltages and a controller coupled to the information acquisition unit for selecting one of a plurality of charging modes in which the battery cells are charged by a charger according to the cell voltages.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a battery management system, in accordance with one embodiment of the present invention.

FIG. 2 illustrates a flowchart of operations performed by a battery management system, in accordance with one embodiment of the present invention.

FIG. 3 illustrates an example of a flowchart of operations performed by a battery management system, in accordance with one embodiment of the present invention.

FIG. 4 illustrates an example of a flowchart of operations performed by a battery management system in a pulse charging mode, in accordance with one embodiment of the invention.

FIG. 5 illustrates an example of a waveform of signals in a battery management system in a charging mode, in accordance with one embodiment of the present invention.

FIG. 6 illustrates an example of a waveform of signals in a battery management system in a pulse charging mode, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

In one embodiment, a battery management system for a battery including multiple battery cells includes an information acquisition unit and a controller coupled to the information acquisition unit. The information acquisition unit monitors cells voltages of the battery cells. The controller selects one of multiple charging modes in which the battery cells are charged according to the voltages of the battery cells (referred to as “cell voltages”). The charging modes include, but are not limited to, a constant current charging mode, a constant voltage charging mode, and a pulse charging mode. The controller switches the charging modes according to the cell voltages.

Advantageously, by switching the battery between different charging modes such as the constant current charging mode, the constant voltage charging mode and the pulse charging mode according to the cell voltages, the battery cells are charged in a faster rate and the capacity of all the battery cells is charged to a higher level relative to a conventional charging mode based upon the voltage of the battery.

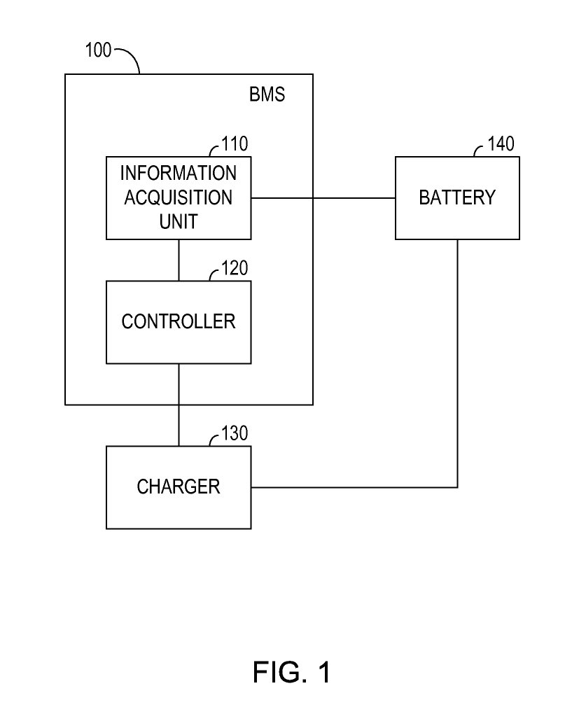

FIG. 1 illustrates a block diagram of a battery management system 100 for a battery 140, in accordance with one embodiment of the present invention. The battery 140 can include, but is not limit to, a lead-acid battery, a lithium-ion battery, a nickel-cadmium battery, or a nickel-metal hydride battery. In one embodiment, the battery 140 includes multiple battery cells coupled in series.

In the example of FIG. 1, the battery management system 100 includes an information acquisition unit 110 and a controller 120 coupled to the information acquisition unit 110. The information acquisition unit 110 can monitor parameters of the battery cells. The parameters of the battery cells include, but are not limited to, voltage, current, temperature, and capacity of the battery cells.

In one embodiment, the controller 120 selects a charging mode according to the cell voltages and controls a charger 130 to charge the battery cells in the battery 140 in a selected charging mode. More specifically, the controller 120 generates a control signal to select one of multiple charging modes according to the cell voltages. The charging modes include, but are not limited to, a constant current charging mode, a constant voltage charging mode, and a pulse charging mode.

Advantageously, the selection of the charging modes is implemented according to the cell voltages so as to regulate the charging current or voltage of the charger 130. Hence, the battery cells are charged in a faster rate and the capacity of all the battery cells is charged more fully.

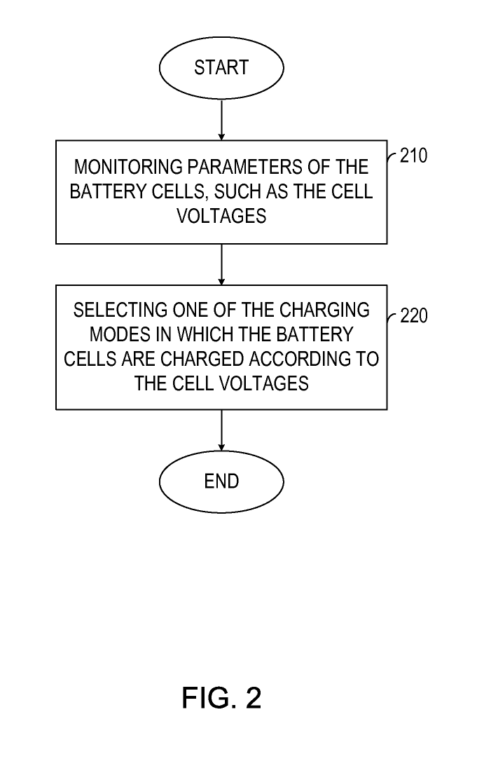

FIG. 2 illustrates a flowchart of operations performed by the battery management system 100, in accordance with one embodiment of the present invention. FIG. 2 is described in combination with FIG. 1.

In block 210, the information acquisition unit 110 monitors the parameters of the battery cells, e.g., the cell voltages. In block 220, the controller 120 selects one of the charging modes in which the battery cells are charged according to the cell voltages. More specifically, the controller 120 generates a control signal according to the cell voltages, thereby to select a corresponding charging mode. The selection of the corresponding charging mode will be described in further detail below.

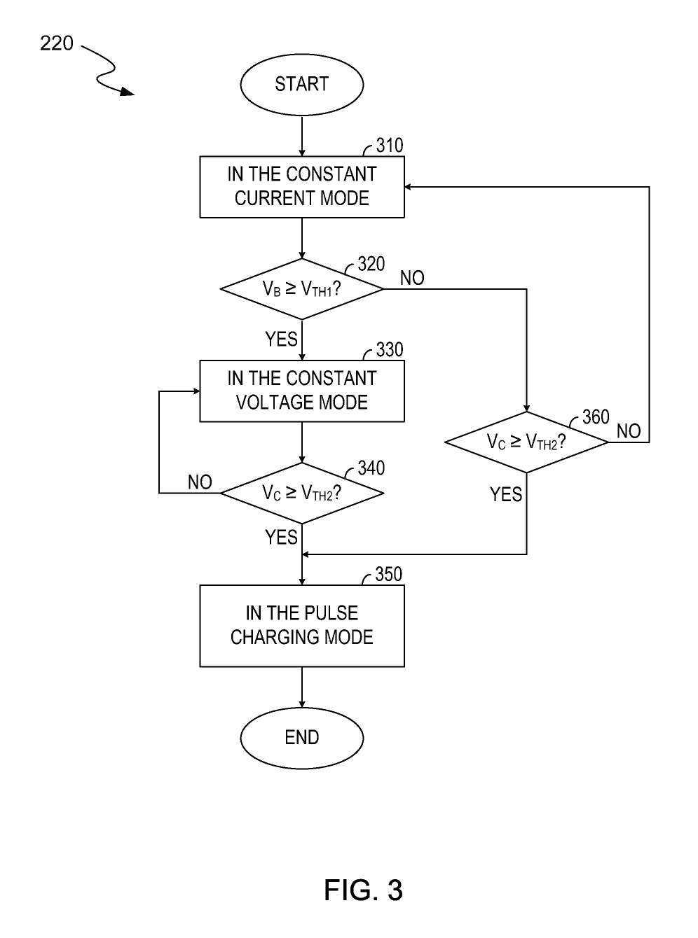

FIG. 3 illustrates an example of the flowchart 220 of operations performed by the battery management system 100, in accordance with one embodiment of the present invention. FIG. 3 is described in combination with FIG. 1 and FIG. 2.

In the example of FIG. 3, the controller 120 selects a constant current charging mode in which the charger 130 charges the battery cells by a constant charging current in block 310. The cell voltages gradually increase when the battery cells are charged in the constant current charging mode.

In block 320, the controller 120 compares a summation V_{B} of the cell voltages with a first predetermined voltage V_{TH1}. If the summation V_{B} of the cell voltages is equal to or greater than the first predetermined voltage V_{TH1}, the controller 120 selects a constant voltage charging mode in block 330. More specifically, the controller 120 switches the charger 130 from the constant current charging mode to the constant voltage charging mode, in which the battery is charged by a constant charging voltage, e.g., the first predetermined voltage V_{TH1}. The charging current gradually decreases and the voltage of the battery 140 remains constant when the battery is charged in the constant voltage charging mode.

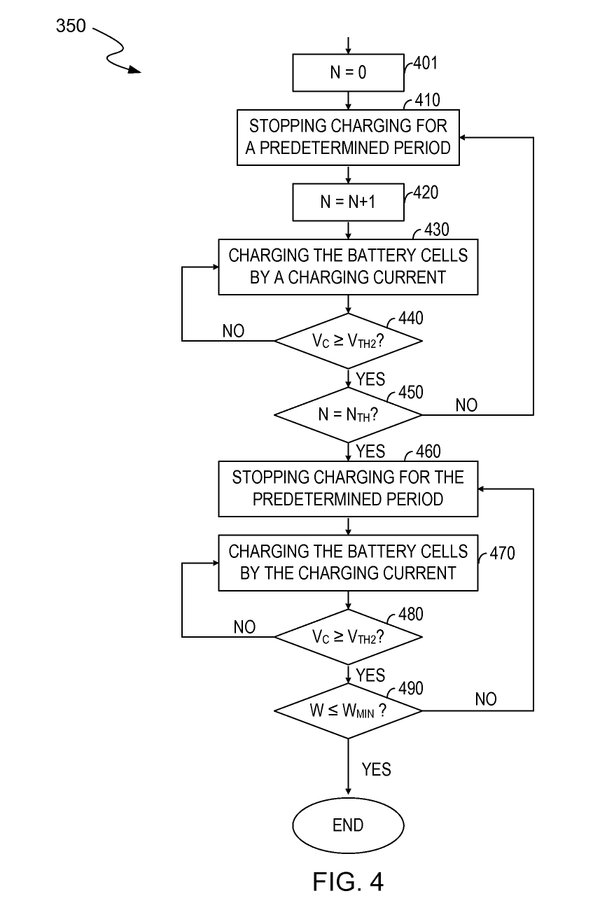

If the summation V_{B} of the cell voltages is less than the first predetermined voltage V_{TH1}, the flowchart 220 goes to block 360 in which the controller 120 compares the cell voltages V_{C} with a second predetermined voltage V_{TH2}. If one of the cell voltages V_{C} is equal to or greater than the second predetermined voltage V_{TH2}, which means a fault condition such as an overvoltage condition occurs to the corresponding battery cell, the controller 120 selects a pulse charging mode to charge the battery 140 in block 350. More specifically, the controller 120 switches the charger 130 from the constant current charging mode to the pulse charging mode and the battery cells in the battery 140 are charged by an intermittent charging current (i.e., a pulse charging current), which will be described in more detail in combination with FIGS. 4-6. Otherwise, the flowchart 220 returns to block 310 in which the battery cells are charged in the constant current charging mode.

In block 340, the controller 120 compares the cell voltages V_{C} with the second predetermined voltage V_{TH2}. If one of the cells voltages V_{C} is equal to or greater than the second predetermined voltage V_{TH2}, which means a fault condition such as an overvoltage condition occurs to the corresponding battery cell, the controller 120 selects a pulse charging mode in block 350. More specifically, the controller 120 switches the charger 130 from the constant voltage charging mode to the pulse charging mode in which the battery cells are charged by the intermittent charging current.

If there is no cell voltages V_{C} equal to or greater than the second predetermined voltage V_{TH2}, the flowchart 220 returns to block 330 in which the charger 130 continues to charge the battery in the constant voltage charging mode.

Accordingly, by switching the battery 140 in different charging modes such as the constant current charging mode, the constant voltage charging mode and the pulse charging mode according to the cell voltages, the battery cells in the battery 140 are charged in a multi-stage charging mode.

In one embodiment, in a first stage, the battery cells are charged in the constant current charging mode in block 310. When the voltage of the battery 140, e.g., the summation V_{B} of the cell voltages is equal to or greater than the first predetermined voltage V_{TH1}, the charger 130 is switched from the constant current charging mode to the constant voltage charging mode under control of the controller 120. In a second stage, the battery is charged in the constant voltage charging mode in block 330. When one of the cell voltages V_{C} is equal to or greater than the second predetermined voltage V_{TH2}, the charger 130 is switched from the constant voltage charging mode to the pulse charging mode under control of the controller 120. In a third stage, the battery cells are charged in the pulse charging mode in block 350.

Advantageously, the battery 140 is charged to the first predetermined voltage V_{TH1} in the constant current charging mode which has a fast charging rate. The constant voltage charging mode takes a constant voltage such as the first predetermined voltage V_{TH1} to charge the battery 140, keeping the voltage of the battery 140 equal to the first predetermined voltage V_{TH1}, thereby to charge the battery 140 to a full state and protect the whole battery 140 from an overcharge condition. The pulse charging mode impels all the battery cells in the battery 140 to be charged more fully. Consequently, the combination of the constant current charging mode, the constant voltage charging mode and the pulse charging mode facilitates the charging of the battery 140 and the capacity of the battery 140 is fuller.

In an alternative embodiment, in a first stage, the battery cells are charged in the constant current charging mode in block 310. When the summation of the cell voltages V_{B} is less than the first threshold V_{TH1}, but one of the cell voltages V_{C} is equal to or greater than the second predetermined voltage V_{TH2}, under control of the controller 120, the charger 130 is switched from the constant current charging mode to the pulse charging mode. In a second stage, the battery cells are charged in the pulse charging mode in block 350.

Advantageously, the constant current charging mode charges the battery 140 with a fast rate and the pulse charging mode impels all the battery cells in the battery 140 to be charged fuller. Hence, the combination of the constant current charging mode and the pulse charging mode facilitates the charging of the battery 140 and the capacity of the battery 140 is fuller.

As the example of FIG. 3, “constant” herein means the variation of the charging current or the charging voltage of the charger 130 is within a predetermined range.

Additionally, if the battery 140 is discharged to a low capacity level, the battery 140 will be pre-charged by a predetermined small current before being charged in the constant current charging mode in block 310. Advantageously, the pre-charging process (not shown) can protect the battery 140 from being destroyed, and extend the lifetime of the battery 140.

Additionally, after the pulse charging mode, the controller 120 switches the charger 130 to a reflex charging mode (not shown). In the reflex charging mode, the charger 130 charges the battery by a predetermined small voltage. The reflex charging mode ends after a predetermined time period. The charging of the battery cells in the reflex charging mode can compensate the capacity of the battery cells cost by the self-discharging of the battery cells.

FIG. 4 illustrates an example operations performed by the battery management system 100 in a pulse charging mode shown in block 350 of FIG. 3, in accordance with one embodiment of the invention. In the pulse charging mode, charging of a battery is paused intermittently before continuing with additional charging. FIG. 4 is described in combination with FIG. 1 and FIG. 3.

In block 401, a parameter N is set to an initial value, e.g., 0, by the controller 120. In block 410, the controller 120 pauses charging the battery cells for a predetermined time interval. In block 420, the parameter N is incremented by 1. In block 430, the controller 120 selects a charging current less than the previous charging current and the battery cells are charged by the newly selected charging current. In block 440, the controller 120 compares the cell voltages V_{C} with the second threshold voltage V_{TH2}. If one of the cell voltages V_{C} is equal to or greater than the second threshold voltage V_{TH2}, the flowchart 350 goes to block 450. Otherwise, the flowchart returns to block 430 where the charger 130 continues to charge the battery cells by the previous selected charging current.

In block 450, the controller 120 compares the parameter N with a total number N_{TH} representing predetermined times of the charging current being decreased. If the parameter N is equal to the total number N_{TH}, the flowchart 350 goes to block 460. Otherwise, the flowchart 350 returns to block 410 in which the charging of the battery cells is paused for the predetermined time interval.

In block 460, the controller 120 pauses the charging of the battery cells for the predetermined time interval. After the predetermined time interval, the charger 130 resumes charging the battery cells by the charging current in block 470. In other words, the battery cells are charged in the constant current charging mode. In block 480, the controller 120 compares every cell voltage V_{C} with the second predetermined voltage V_{TH2}. If there is no cell voltage V_{C} less than the second threshold voltage V_{TH2}, the flowchart returns to block 470 in which the charger 130 continues to charge the battery cells by the charging current.

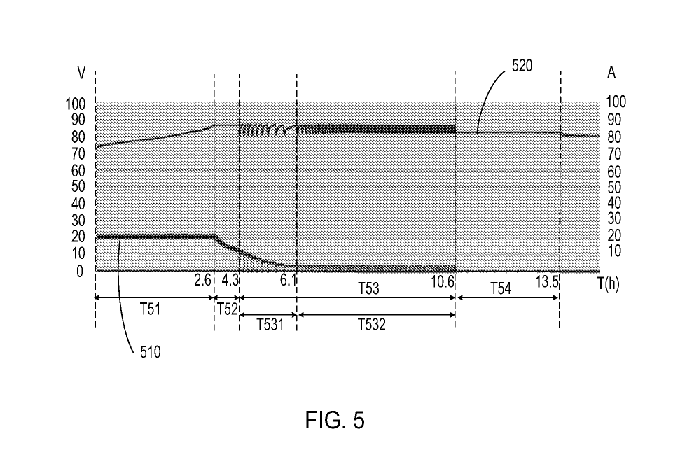

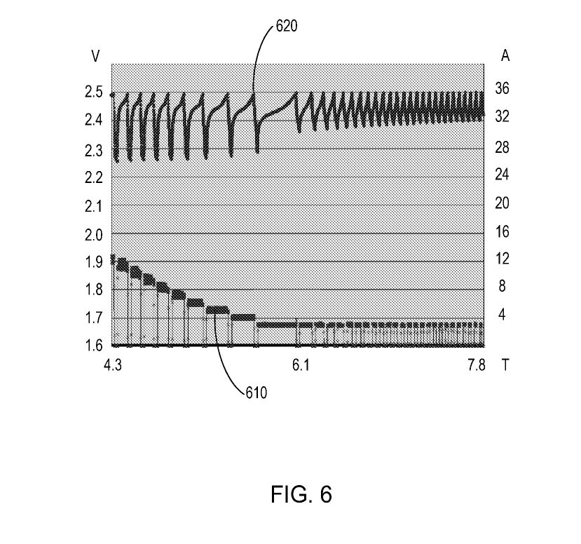

If one of the cell voltages V_{C} is equal to or greater than the second threshold voltage V_{TH2}, the controller 120 compares a pulse width W of the charging current with a predetermined width W_{MIN} in block 490. As discussed above, the charging of the battery cells pauses when one of the cell voltages Vc equal to or larger than the second threshold voltage V_{TH2}, and the battery cells resume charging after the predetermined time interval. The charging current is equal to about zero amperes during the predetermined time interval, and shown as a pulse charging current or an intermittent charging current Therefore, the pulse width W of the charging current corresponds to a time period from a moment the charger 130 resumes charging to a moment one of the cell voltage Vc equal to or larger than the second threshold voltage V_{TH2}, which will be described in more detail in combination with FIG. 5 and FIG. 6. If the pulse width W of the charging current is equal to or less than the predetermined width W_{MIN}, the controller 120 stops the pulse charging mode. Otherwise, the flowchart 350 returns to block 460 in which the charging of the battery cells is paused for the predetermined time interval.

FIG. 5 is an example of a waveform of signals in the battery management system 100 in the charging mode in accordance with one embodiment of the present invention. Waveform 510 illustrates a charging current by which the charger 130 charges the battery cells in the battery 140. Waveform 520 illustrates the voltage of the battery 140. FIG. 5 is described in combination with FIG. 1, FIG. 3, and FIG. 4.

As the example of FIG. 5, in a first stage T51, the controller 120 selects a constant current charging mode. In the constant current charging mode, the charger 130 charges the battery cells by a constant charging current and the voltage of the battery 140 gradually increases. The first stage T51 is implemented in block 310 in FIG. 3.

In a second stage T52, the controller 120 selects the constant voltage charging mode when the summation V_{B} of the cell voltages is equal to or greater than the first predetermined voltage V_{TH1}. In one embodiment, the charger 130 charges the battery 140 with the first predetermined voltage V_{TH1} in the constant voltage charging mode. The charging current gradually decreases and the voltage of the battery 140 remain constant, e.g., the first predetermined voltage V_{TH1}. The second stage T52 is implemented in block 330 in FIG. 3.

In a third stage T53, the controller 120 selects the pulse charging mode when one of the cell voltages V_{C} is equal to or greater than the second predetermined voltage V_{TH2}. In the pulse charging mode, the charger 130 charges the battery cells with an intermittent charging current. In one embodiment, the third stage T53 is further includes a first part T531 and a second part T532.

More specifically, in the first part T531, the controller 120 pauses the charging of the battery cells for a predetermined time interval. Then, the controller 120 selects a charging current less than the previous charging current to continue to charge the battery cells. The charging of the battery cells with the charging current will continue until one of the cell voltages V_{C} is equal to or greater than the second predetermined voltage V_{TH2}. Then, pausing the charging operation for the predetermined time interval and the charging of the battery cells by a less charging current will continue until one of the cell voltages V_{C} is equal to or greater than the second predetermined voltage V_{TH2}. Therefore, the charging current in the first part T531 of the third state T53 is gradually decreased until the parameter N is equal to the total number N_{TH}. The first part T531 of the third stage T53 is implemented in block 350 in FIG. 3 and blocks 401-450 in FIG. 4.

The second part T532 of the third stage T53 initiates when the parameter N is equal to the total number N_{TH} in the first part T51. In the beginning of the second part T532, the controller 120 pauses the charging of the battery cells. After the predetermined time interval, the charger 130 charges the battery cells by a charging current continued from the first part T531 when the parameter N is equal to the total number N_{TH}. The charging of the battery cells with the charging current will continue until one of the cell voltages V_{C} is equal to or greater than the second predetermined voltage V_{TH2}. Then, pausing the charging for the predetermined time interval and the charging of the battery cells by the charging current will repeat until one of the cell voltages V_{C} is equal to or greater than the second predetermined voltage V_{TH2} and the pulse width W of the charging current is equal to or less than the predetermined width W_{MIN}. The second part T532 of the third stage T53 s implemented in block 350 of FIG. 3 and block 460-490 of FIG. 4.

In a fourth stage T54, the controller 120 selects the reflex charging mode. In the reflex charging mode, the battery cells are charged by a predetermined small charging current. The reflex charging mode ends after a predetermined time period.

FIG. 6 illustrates an example of a waveform of signals in the battery management system 100 in the pulse charging mode, in accordance with one embodiment of the present invention. Waveform 610 illustrates a variation of a charging current of the battery cells in the pulse charging mode. As the example of FIG. 6, the charging current of the battery cells is in pulse mode. Waveform 620 illustrates a variation of a highest cell voltage among the cell voltages in the pulse charging mode. FIG. 6 is described in combination with FIG. 4.

In one embodiment, the charger 130 is switched from the constant voltage charging mode to the pulse charging mode when one of the cell voltages V_{C}, e.g. the highest cell voltage among the cell voltages, is equal to or greater than the second predetermined voltage V_{TH2}, e.g., 2.5 volts, and the charging of the battery cells is paused for a predetermined time interval. The charging current of the battery cells is equal to about zero amperes during the predetermined time interval. After the predetermined time interval, the charger 130 resumes charging the battery cells by a charging current less than the previous charging current until one of the cell voltages V_{C} is equal to or greater than the second predetermined voltage V_{TH2}. The charging of the battery cells is paused again. The cycle of pausing the charging of the battery cells for the predetermined time interval and resuming the charging of the battery cells by the charging current less than the previous charging current will repeat until one of the cell voltages V_{C}, e.g. the highest cell voltage, is equal to or greater than the second threshold voltage V_{TH2}, e.g., 5 volts, and the parameter N is equal to the total number N_{TH}.

Then, the battery cells are charged by the charging current to a value equal to or greater than the second threshold voltage V_{TH2}, e.g., 2.5 volts. After the charging of the battery cells is paused for the predetermined time interval, the charger 130 restarts the charging of the battery cells by the charging current.

Hence, the repetition of non-charging and charging of the battery cells produces a pulse charging current (i.e., an intermittent charging current). When the battery cells are charged in the pulse charging mode, faster the cell voltage is charged to the second predetermined voltage, less the pulse width of the charging current is. The charging of the battery cells ends until one of the cell voltages, e.g., the highest cell voltage, is equal to or greater than the second predetermined voltage and the pulse width W of the charging current is equal to or less than the predetermined width W_{MIN}.

Accordingly, embodiments in accordance with the present invention provide a battery management system for a battery including multiple battery cells. The battery management system includes an information acquisition unit, a controller, and a charger. The information acquisition unit monitors the voltage of each cell in the battery and also gets the summation of the voltages of all the cells in the battery. The controller selects one of the multiple charging modes in which the battery cells are charged by the charger according to the cell voltages. The charging modes includes, but is not limited to, a constant current charging mode, a constant voltage charging mode, and a pulse charging mode.

While the controller selects the constant current charging mode, if the summation of the cell voltages is equal to or greater than a first predetermined voltage in the constant current charging mode, the controller switches the charger from the constant current charging mode to the constant voltage charging mode. Otherwise, the controller switches the charger from the constant current charging mode to the pulse charging mode if one of the cell voltages is equal to or larger than a second predetermined voltage.

If one of the cell voltages is equal to or greater than the second predetermined voltage in the constant voltage charging mode, the controller switches the charger from the constant voltage charging mode to the pulse charging mode. The pulse charging mode ends when the width W of the pulse charging current is equal to or less than the predetermined width W_{TH}.

Advantageously, due to the multi-stage technology used for charging the battery cells, the battery cells are charged in a faster rate and the capacity of the battery cells is relatively full.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A method for managing a battery composed of a plurality of battery cells, said method comprising:
monitoring parameters of said battery cells by an information acquisition unit, wherein said parameters comprise cell voltages; and
selecting, by a controller, one of a plurality of charging modes in which said battery cells are charged according to said cell voltages, wherein said charging modes comprises a constant current charging mode, a constant voltage charging mode, and a pulse charging mode.

2. The method of claim 1, further comprising:
switching to said constant voltage charging mode if the summation of said cell voltages is equal to or greater than a first predetermined voltage in said constant current charging mode.

3. The method of claim 2, further comprising:
switching to said pulse charging mode if one of said cell voltages is equal to or greater than a second predetermined voltage in said constant voltage charging mode.

4. The method of claim 1, further comprising:
switching to said pulse charging mode if the summation of said cell voltages is less than a first predetermined voltage and one of said cell voltages is equal to or greater than a second predetermined voltage in said constant current charging mode.

5. The method of claim 1, further comprising:
stopping said pulse charging mode if one of said cell voltages is equal to or greater than a predetermined voltage and the pulse width of a charging current is less than a predetermined width in said pulse charging mode.

6. The method of claim 1, further comprising:
stopping said pulse charging mode if one of said cell voltages is equal to or greater than a predetermined voltage in said pulse charging mode.

7. The method of claim 1, further comprising:
(a) stopping charging said battery cells if one of said cell voltages is equal to or greater than a predetermined voltage in said pulse charging mode;
(b) selecting a charging current less than a previous charging current;
(c) resuming charging said battery cells by said selected charging current after a predetermined time interval; and
(d) repeating the cycle defined by (a), (b), and (c) until one of said cell voltages is equal to or greater than said predetermined voltage and the number of selecting said charging current is equal to a predetermined value.

8. The method of claim 7, further comprising:
(e) stopping the charging of said battery cells for said predetermined time interval;
(f) charging said battery cells by said selected charging current; and
(g) repeating (e) and (f) until one of said cell voltages is equal to or greater than said predetermined voltage and the pulse width of said charging current is equal to or less than a predetermined width.

9. A battery management system for a battery composed of a plurality of battery cells, said battery management system comprising:
an information acquisition unit for monitoring parameters of said battery cells, wherein said parameters comprise cell voltages; and
a controller coupled to said information acquisition unit, the controller selecting one of a plurality of charging modes in which said battery cells are charged by a charger according to said cell voltages, wherein said charging modes comprises a constant current charging mode, a constant voltage charging mode, and a pulse charging mode.

10. The battery management system of claim 9, wherein said controller switches said charger to said constant voltage charging mode if the summation of said cell voltages is equal to or greater than a first predetermined voltage in said constant current charging mode.

11. The battery management system of claim 10, wherein said controller switches said charger to said pulse charging mode if one of said cell voltages is equal to or greater than a second predetermined voltage in said constant voltage charging mode.

12. The battery management system of claim 9, wherein said controller switches said charger to said pulse charging mode if the summation of said cell voltages is less than a first predetermined voltage and one of said cell voltages is equal to or greater than a second predetermined voltage in said constant current charging mode.

13. The battery management system of claim 9, wherein said controller stops said pulse charging mode if one of said cell voltages is equal to or greater than a predetermined voltage and the pulse width of a charging current is less than a predetermined width in said pulse charging mode.

14. The battery management system of claim 9, wherein said controller stops said pulse charging mode if one of said cell voltages is equal to or greater than a predetermined voltage in said pulse charging mode.

15. The battery management system of claim 9, wherein (a) said controller stops the charging of said battery cells if one of said cell voltages is equal to or greater than a predetermined voltage in said pulse charging mode and selects a charging current less than the previous charging current, and (b) said charger charges said battery cells by said charging current after a predetermined time interval.

16. The battery management system of claim 15, wherein (a) and (b) are repeated until one of said cell voltages is equal to or greater than said predetermined voltage and the times of selecting said charging current is equal to a predetermined value.

17. The battery management system of claim 16, wherein (c) said controller stops the charging of said battery cells for said predetermined time interval, and (d) said charger charges said battery cells by said charging current.

18. The battery management system of claim 17, wherein (c) and (d) are repeated until one of said cell voltages is equal to or greater than said predetermined voltage and the pulse width of said charging current is equal to or less than a predetermined width.
